(19) United States
(12) Patent Application Publication
(10) Pub. No.: US 2007/0288308 A1
(43) Pub. Date: Dec. 13, 2007

(54) Method and system for providing job listing affinity

(75) Inventors: Changsheng Chen, Hayward, CA (US); Adam Hyder, Los Altos, CA (US)

Correspondence Address: GREENBERG TRAURIG, LLP, MET LIFE BUILDING, 200 PARK AVENUE, NEW YORK, NY, 10166, US

(73) Assignee: Yahoo Inc., Sunnyvale, CA (US)

(21) Appl. No.: 11/442,108

(22) Filed: May 25, 2006

(51) Int. Cl. G07G 1/14

(52) U.S. Cl. 705/14; 283/67

(57) ABSTRACT

A method and system of establishing affinity of two job listings is disclosed. A first job listing is identified. The first job listing has a first job listing attribute. A second job listing is identified. The second job listing has a second job listing attribute. A first job listing attribute value and a second job listing attribute value are compared to determine if the first job listing attribute and the second job listing attribute are similar according to a predefined set of rules. The first job listing and the second job listing are affiliated if the first job listing attribute and the second job listing attribute are determined to be similar.

### BACKGROUND

1. Field

This disclosure relates to systems and method for establishing affinity of two job listings utilizing job listing attributes and jobseeker selection patterns.

2. General Background

Various search engines are available to users who view, apply for, request, purchase, and subscribe to items offered on World Wide Web and other information sharing infrastructures. In addition, the exponential growth of the number of items offered on the World Wide Web can frustrate and confuse users when attempting to locate a needed item.

In particular, jobseekers can be assisted if job listing services recommend relevant job listings which have been determined to have an affinity with jobs previously applied for by the jobseeker. By doing this, jobseekers, employers, and job listing services benefit. The jobseeker has a more pleasant experience and may quickly locate a job listing that are pertinent to his needs. In addition, the employer can receive a greater number of jobseeker applications for a particular job.

### SUMMARY

In one aspect, there is a method and of establishing affinity of two job listings is disclosed. A first job listing is identified. The first job listing has a first job listing attribute. A second job listing is identified. The second job listing has a second job listing attribute. A first job listing attribute value and a second job listing attribute value are compared to determine if the first job listing attribute and the second job listing attribute are similar according to a predefined set of rules. The first job listing and the second job listing are affiliated if the first job listing attribute and the second job listing attribute are determined to be similar.

The second job listing can be recommended to a new jobseeker when the new jobseeker selects the first job listing, if the first job listing and the second job listing are affiliated. The first job listing can be recommended to a new jobseeker when the new jobseeker selects the second job listing, if the first job listing and the second job listing are affiliated.

In a further aspect of the method, the job listings can be posted on an Internet website hosted by a computer server, wherein the jobseeker can apply to the first job listing and the second job listing electronically through a computing device that communicates with the computer server through a computer network.

Furthermore, in another aspect of the method, the set of rules can indicate that the first job listing attribute and the second job listing attribute are similar when the first job listing attribute value and the second job listing attribute value are identical. Alternatively, the set of rules can indicate that the first job listing attribute and the second job listing attribute are similar when the first job listing attribute value and the second job listing attribute value are deemed equivalent based on a heuristic model. Yet, in another aspect, the set of rules indicate that the first job listing attribute and the second job listing attribute are similar according to a predetermine table of value pairs that are considered to be similar.

In a further aspect of the method, the first job listing attribute is a first location of the first job listing, and the second job listing attribute is a second location of the second job listing. Alternatively, the first job listing attribute is a first title of the first job listing, and the second job listing attribute is a second title of the second job listing. In another aspect, the first job listing attribute is a first industry of the first job listing, and the second job listing attribute is a second industry of the second job listing. In yet another aspect, the first job listing attribute corresponds to a list of jobseekers that have applied to the first job listing, and the second job listing attribute corresponds to a list of jobseekers that have applied to the second job listing.

In one aspect, there is a system that establishes affinity of job listings, comprising a jobs database and an affinity module. The jobs database includes a first job listing and a second job listing. The first job listing can have a first job listing attribute, and the second job listing can have a second job listing attribute. The affinity module can be configured to compare a first job listing attribute value and a second job listing attribute value to determine if the first job listing attribute and the second job listing attribute are similar according to a predefined set of rules. The affinity module affiliates the first job listing and the second job listing if the affinity module determines that the first job listing attribute and the second job listing attribute are similar.

In yet another aspect, there is a method of establishing affinity of job listings. A first job listing and a second job listing are identified. A number of jobseekers that apply for the first job listing and the second job listing is determined. The first job listing and the second job listing are affiliated if the number of jobseekers that apply for both the first job listing and the second job listing is higher than a predetermined threshold.

### DRAWINGS

By way of example, reference will now be made to the accompanying drawings.

FIG. 1 illustrates a system for determining and communicating jobs affinity.

FIG. 2 illustrates a block diagram of a computing device.

FIG. 3 illustrates a flow diagram of a process of determining job.

FIG. 4 illustrates two jobs in the jobs database.

FIG. 5 illustrates an exemplary similarity table of job industries.

FIGS. 6A-6D illustrate exemplary jobs listed by the job listing provider.

FIG. 7A illustrate an exemplary job list for a predefined job location.

FIG. 7B illustrate an exemplary job list for a predefined job location and corresponding affiliated job listings for a predefined job location.

FIG. 8 illustrates a flow diagram for a process of determining job affinity between two job listings.

FIG. 9 illustrates an exemplary list of jobs selected by a plurality of jobseekers.

FIG. 10 illustrate exemplary affinity score table for a plurality of job pair combinations.

FIG. 11 illustrate an exemplary list of jobs and corresponding related jobs for each job in the list of jobs.

### DETAILED DESCRIPTION

The methods and systems disclosed herein are directed to establishing affinity of job listings utilizing job listing attributes. As such, affinity of two job listings can be established utilizing the similarity between attribute values of each of the two job listings. Therefore, the affinity between job listings can be multi-dimensional in the sense that each attribute of a job listing is a dimension upon which an affinity between job listings can be determined. One such dimension can be a location attribute. Another such dimension can be a title attribute. Yet another dimension can be a jobseeker attribute that represents the job listing.

In one aspect, an affinity between two job listings can be calculated purely based on an attribute common to the two job listings and that is unrelated to jobseeker interaction. For example, a location attribute can be utilized to determine the affinity of two job listings, and there would be no need to utilize jobseeker data. In another example, if the title attribute of a job listing is utilized to determine the affinity of two job listings, then user interaction is not needed either. In general, any job listing attribute that is not a user attribute can be utilized as the basis for making a comparison between two job listings in order to determine affinity of the two job listings.

It is possible, therefore, to determine an affinity between a new job listing that has not necessarily been applied for by a jobseeker and an old job listing. Thus, for example, if a new job listing is posted, a location affinity can be established between the new job listing in relation to existing job listings that are located in the same area. This affinity can be established in real time or near real time such that the new job listing can be immediately or timely recommended to jobseekers. As a result, recommendations of new job listings are possible, even when jobseekers have not applied for such jobs.

In another aspect, an affinity between two jobs can be calculated based on a jobseeker attribute. The value of the jobseeker attribute in each job listing can be one or more jobseeker identifiers that represent the jobseekers who have applied for the job listing. Therefore, two job listings can be deemed to have an affinity based on the jobseeker attribute if the jobseeker attribute of the first job listing is similar to the jobseeker attribute of the second job listing. In one example, similarity of the jobseeker attributes can be established if the number of job seekers that applied to both the first job and the second job is greater than a predetermined threshold. In another example, similarity of the jobseeker attributes can simply be a score that is proportional to the number job seekers that applied to both the first job and the second job.

Attribute similarity can be measured utilizing a similarity score. In addition, an affinity score can be calculated by adding the similarity scores of the attributes of two job listings. As the sum of the similarity scores increase, the affinity score can also increase thus increasing the affinity between the two job listings. For example, a high affinity score means that two job listings are strongly related.

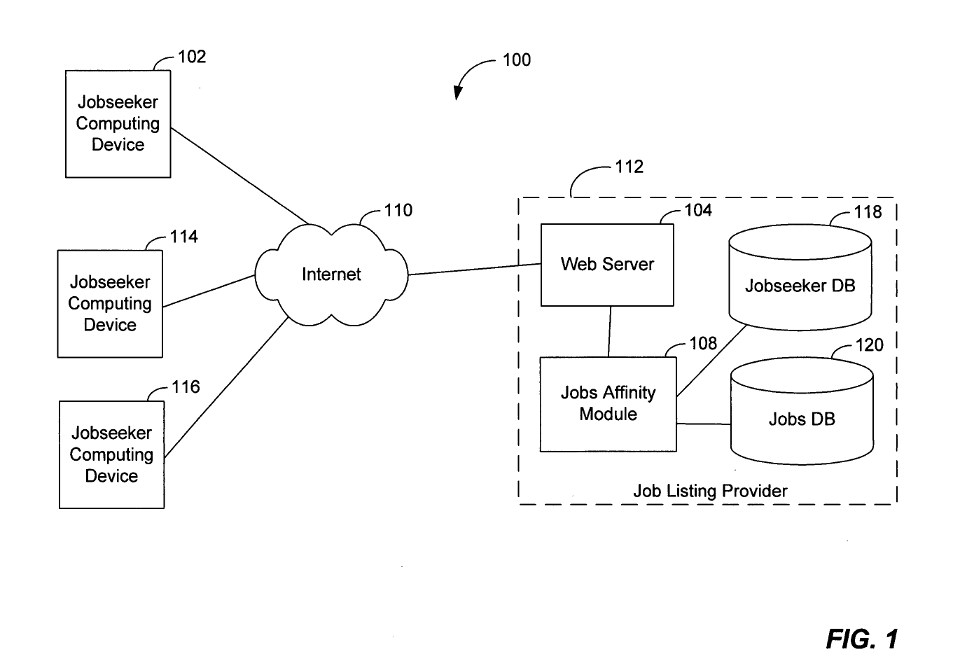

FIG. 1 illustrates a system for determining and communicating jobs affinity. A jobseeker can select a job by accessing a job listing provider 112 through jobseeker computing devices 102, 114, and 116. The job listing provider 112 can be a job listing website, a service provider, etc. The job listing provider 112 can be accessible by multiple jobseekers who select, rate, view, or apply for jobs provided by the job listing provider 112. One or more jobseekers can communicate with the job listing provider 112 through the Internet 110 or any other communication network.

The job listing provider 112 can include a web server 104 that transmits and receives data messages with the jobseeker computing devices 102, 114, and 116. The jobseeker computing devices 102, 114, and 116, and the web server 104 can utilize communication protocols such as HTTP. A jobseeker database 118 can store jobseeker profiles which in turn can include a record of jobs previously selected by the jobseeker. The jobseeker database 118 can also store jobseeker preferences, personal information, job application patterns, resume, etc.

The job listing provider 112 further includes affinity module 108 which can reside on a standalone computer. In another embodiment, the affinity module 108 resides in the server 106. The affinity module 108 may include logic to determine affinity between two jobs stored at the jobs database 112. The affinity module 108 is further configured with logic to access, write and read data from the jobs database 120 as well as from the jobseeker database 118. Job affinity can then be utilized by the jobs affinity module 108 to formulate job recommendations and relay job recommendations to the jobseeker. In another embodiment, a recommending module (not shown) can be utilized to formulate recommendations based on job affinity.

As previously stated, the affinity module 108 can be configured to determine the affinity of job listings based on attributes of the job listings, and independent of user interaction or selection of the job listings.

In one embodiment, affinity of two job listings can be represented by a similarity score s(Job 1, Job 2, Ai), where Ai is an attribute of Job 1 and Job 2. If the similarity score s(Job 1, Job 2, Ai) is greater than a predefined threshold, then Job 1 and Job 2 are affiliated. In one example, the threshold t can be between zero and one (e.g., 0<=t<=1). In another example, the threshold t can be a number within any other range. The threshold can be set by a system operator or administrator, or by a jobseeker, or programmatically, or by some combination thereof. A total affinity score of two job listings can be calculated utilizing the similarity scores of all the attributes of Job 1 and Job 2.

In another embodiment, affinity A(Job 1, Job 2) of two job listings can be established by comparing each of attribute1 . . . attributeM of Job 1, with each of attribute1 . . . attributeN of Job 2. In particular, each attribute of Job 1, attributeᵢ in (attribute₁ . . . attribute_{M}), is compared to each attribute of Job 2, attributeⱼ in (attribute₁ . . . attribute_{N}). In one embodiment, if attributeᵢ is equal to attributeᵢ, then attributeᵢ is added to A(Job 1, Job 2). In another embodiment, if attributeᵢ is similar, based on a similarity table, to attributeᵢ, then attributeᵢ is added to A(Job 1, Job 2). In another embodiment, if attribute₁ is equal to attributeᵢ, then a number with a value of one is added to A(Job 1, Job 2).

In another embodiment, the affinity A(Job 1, Job 2) is established as follows. Job 1 can have an attributeᵢ of a plurality of attributes, attribute₁ . . . attribute_{M}. In addition, attributeᵢ can have nᵢ values. Job 2 also has an attributeⱼ of a plurality of attributes, attribute₁ . . . attribute_{N} of Job 2. In addition, attributeⱼ can have nⱼ values. Finally, nᵢⱼ is the number of values that are common to attribute₁ and attributeⱼ. In one embodiment, the affinity A(Job 1, Job 2) can be established according to the following formula: (nᵢⱼ/nᵢ+nᵢⱼ/nⱼ)/2. In another embodiment, the affinity A(Job 1, Job 2) can be established according to the following formula: (n₁₋₁/n₁+n₁₋₁/n₁)/2+ . . . +(nᵢⱼ/nᵢ+nᵢⱼ/nⱼ)/2+ . . . +(n_{NM}/n_{N}+n_{NM}/n_{M})/2.

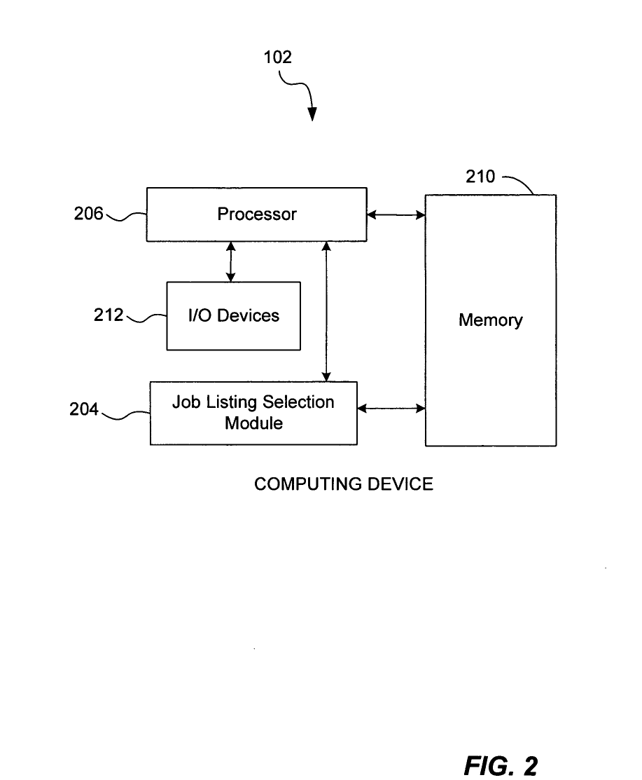

FIG. 2 illustrates a block diagram of an example of a computing device 102. Specifically, the computing device 102 may be employed by a user to select job listings from the job listing provider 114, transmit user information, or to receive affinity information. In one embodiment, the computing device 102 is implemented using a general-purpose computer or any other hardware or software equivalents. Thus, the computing device 102 generally comprises processor 206, memory 210, e.g., random access memory (RAM) and/or read only memory (ROM), job listing selection module 204, and various input/output devices 212, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands)).

It should be understood that the job listing selection module 204 may be implemented as one or more physical devices that are coupled to the processor 206 through a communication channel. Alternatively, the job listing selection module 204 may be represented by one or more software applications (or even a combination of software and hardware, e.g., using application specific integrated circuits (ASIC)), where-the software is loaded from a storage medium, (e.g., a magnetic or optical drive or diskette) and operated by the processor 206 in the memory 210 of the computing device 102. As such, the job listing selection module 204 (including associated data structures) of the present invention may be stored on a computer readable medium, e.g., RAM memory, magnetic or optical drive or diskette and the like.

The job listing selection module 204 can be utilized by a user to make job listing selections, such as applying for a job listing from an Internet website. In addition, the job listing selection module 204 can receive job listing affinity data from the server 106. The job listing selection module 204 can be configured to automatically make selection decisions based on affinity data and recommendations received from the server 114.

The job listing selection module 204 can be a computer application such as by way of non-limiting example an Internet browser, or any other network communication software or hardware that permits a user to interact with the server 106.

In one embodiment, where the affinity of job listings is established independent of user interaction, the job listing selection module 204 is not essential because no user interaction is necessary to establish the affinity of two job listings. In another embodiment, the job listing selection module 204 provides user interaction data which can be utilized to establish job listing affinity based on the number of users that have selected a job listing.

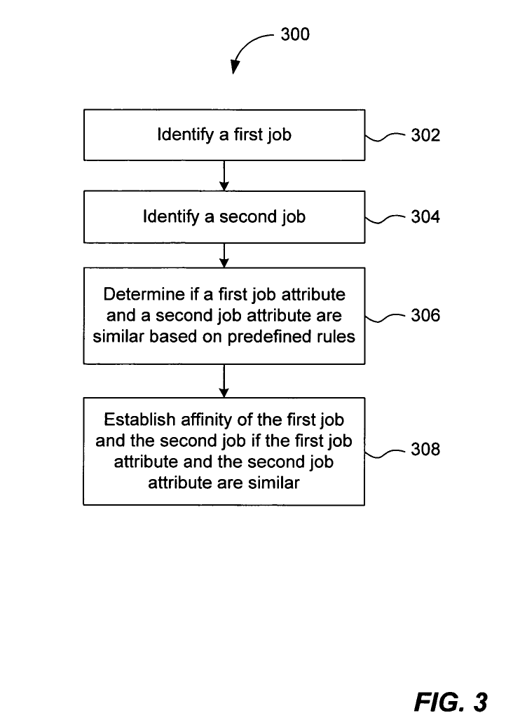

FIG. 3 illustrates a flow diagram of a process of determining job. At process block 302, a first job is identified. In one embodiment, the first job can be identified by accessing the jobs database 120. In addition, the job attributes can also be stored in the jobseeker profile. In addition, the job information, such as attributes, can also be stored in the job database 120. The process 300 continues to process block 304.

At process block 304, a second job is identified. A second job can be also be retrieved from the jobs database 120. In another example, the second job can be obtained from a new entry by the job listing provider 112. The process 300 continues to process block 306.

At process block 306, a similarity between a first job attribute and a second job attribute is determined. The similarity between two attributes can be determined utilizing predefined rules. In one example, a first job attribute and a second job attribute can be deemed similar only if the corresponding values are identical. For example, if the attribute is Location, the Location for a first and a second job is only similar if the location for both jobs is “Chicago.” In another embodiment, the first job attribute and the second job attribute can be deemed similar if there is a match of the first job attribute and the second job attribute in a predefined relational table. In another embodiment, the first and the second attributes are similar based on heuristic models implemented by a system administrator, jobseekers, recruiters, or programmatically. Two attributes values can be similar even when the attribute values are not identical. In one example, two locations can be deemed similar based on proximity. In another example, the predefined relational table can include locations that are similar even though the name of the location is not the same. Further, the table may indicate the level of similarity of the two attributes. For example, a location of San Francisco and a location of Berkley can have a higher similarity location than a location of San Francisco in comparison with San Jose.

Alternatively, the level of selection can be utilized to determine a similarity score. For example, if the jobseeker viewed the first job and the second job, a low similarity score is assumed for both jobs. If the jobseeker applied for both jobs, however, a higher similarity score for the two jobs can be assumed. In addition, the similarity score can then be utilized in the aggregate with other similarity scores of other users. Thus, if a high number of users applied for the same two jobs, there is a greater probability that the two jobs are closely related, which can be reflected in the sum of similarity scores. The process 300 continues to process block 308.

At process block 308, the first job and the second job are established to share affinity if the first job attribute and the second job attribute were determined to be similar. A threshold of similarity can be established. In another embodiment, the threshold of similarity can be predefined by a jobseeker. For example, one jobseeker can establish a high threshold of similarity if the jobseeker only wants to view recommended jobs that have very close affinity to those job listings that the jobseeker has previously viewed or selected. Likewise, another jobseeker can establish a low threshold of similarity if the jobseeker wants to view recommended jobs that are loosely related to those job listings that the jobseeker has previously viewed or selected. In yet another embodiment, the threshold of similarity can be predefined according to the attributes being compared. Thus, in one example, the threshold of similarity can be established to be low for location, but high for the job title. This configuration can be useful for a jobseeker who is willing to relocate but has a high interest in finding a job listing with a specific job title.

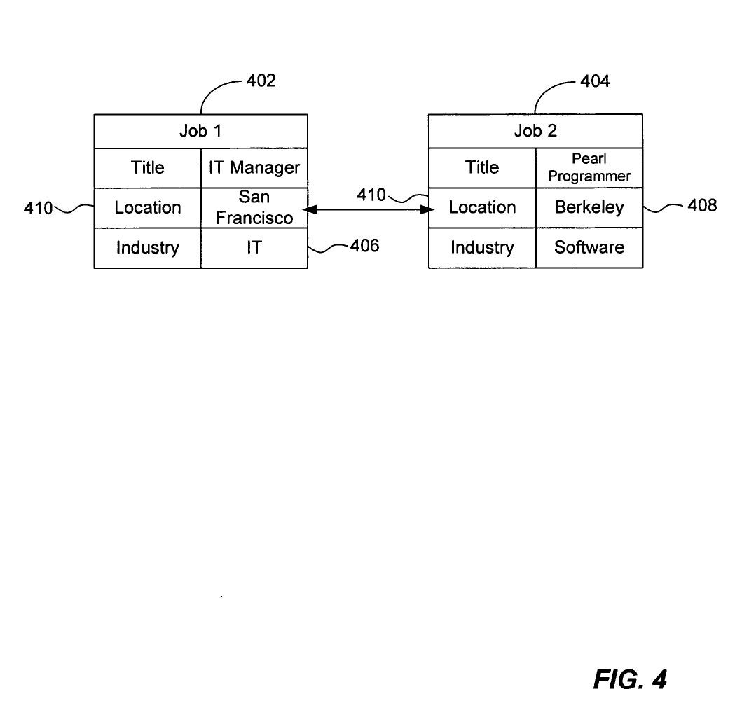

FIG. 4 illustrates two jobs in the jobs database. An affinity relation can be established between a first job 402 and a second job 404. In one embodiment, the first job 402 and the second job 404 include the same attributes such as title location and industry. Of course, the values for each attribute can vary. In another embodiment, the first job 402 and the second job 404 can have different attributes but at least one attribute in common. The attribute in common can be utilized to establish the affinity relation between the first job 402 and the second job 404.

The first job 402 and the second job 404 may include a location attribute 410 which can be utilized as the basis for comparison. If the location attribute value 406 and the location attribute value 408 are deemed similar, then the first job 402 and the second job 404 can be deemed to have an affinity relation. For example, if by virtue of being in the same metropolitan area, location attribute value 406, San Francisco, is deemed similar to the location attribute value 408, Berkley, then the first job 402 and the second job 404 can be affiliated.

A similarity score representative of a similarity between attribute value 406 and attribute value 408 can be determined depending on one or more factors. In one example, the similarity score can be a number between zero and one. In another example, the similarity score can be a number between one and one hundred. In another example, the similarity score can be any number. Moreover, a threshold of similarity can be established to determine when two jobs are related. For example, if the similarity score is greater than a predetermined threshold of similarity then first job 402 and second job 404 can be deemed affiliated.

Job location similarity can be defined in different ways. In one embodiment, a metro area code can be utilized to calculate location similarity such that if two jobs are located in the same metro area, the similarity score between the two jobs can be a high number. For example, the similarity score can be 1 in a scale from 0 to 1. If the two jobs are not in the same metro area, the similarity score can be low, such as 0 in a scale from 0 to 1.

In another embodiment, the location similarity can be calculated utilizing geo-codes. For example, using known algorithms and geoposition data of each of the two jobs locations, the distance between a first job location and a second job location can be determined. In one example, the location similarity score of two jobs can be calculated according to the formula s=1−min((Distance/Base Distance), 1), where the Distance is the distance between the first job location and the second job location. The Base Distance can be calculated according to the formula b=25+(0.6−Location Weight)*30, where the Location Weight is the weight a user assigned for a location attribute.

In yet another embodiment, the location similarity can be determined by executing a lookup operation of a relational table that includes location pairs corresponding to locations that are affiliated. The table can be built according to a uniformly applied formula used for all jobseekers and job listings. In another example, the table can be customized by a jobseeker.

Job title similarity can also be defined in multiple ways. In one embodiment, the job listing provider can utilize a list of standard job titles. When a new job listing is posted, the best fitting standard job title is applied to the new job listing. For example, new jobs with titles of “Programmer,” “Software Developer,” and “Computer Programming” may all be standardized to a title such as “Computer Programmer.” The set of standard job titles allows easily comparing two job titles and determining an accurate similarity score. As an example, in one embodiment, if two jobs match to the same standard job title, the similarity score can be 1 in a scale from 0 to 1. If the two job titles do not match, the similarity score assigned can be 0 in a scale from 0 to 1.

Thus, in order to standardize job titles, various methodologies can be utilized. In one example, standard titles are sorted by length or word count in ascending order. Each job title is matched to the standard titles in the sorted list such that the most descriptive (e.g., largest words count) standard job title is utilized.

Industry similarity can also be defined according to various methodologies. In one embodiment, a list of standard industries can be generated and utilize to assign the correct standard industry for new job listings. In another embodiment, a direct comparison of job industries between a first job and a second job can be conducted. If the industries match, then the similarity score can be 1 in a scale from 0 to 1. If the two job industries do not match, the industry similarity score assigned can be 0 in a scale from 0 to 1. In yet another embodiment, a similarity table with industry listings can be utilized such that similarity scores are predefined for pairs of job industries.

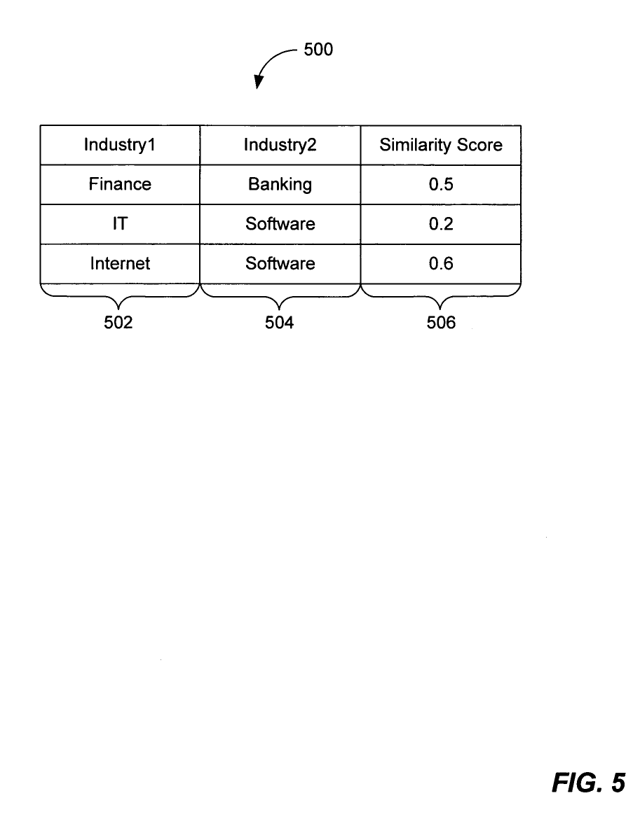

FIG. 5 illustrates an exemplary similarity table 500 of job industries. In one embodiment, the similarity table 500 includes a first industry column 502, a second industry column 504 and a similarity score column 506. A first job industry can be related to a second job industry according to a predefined similarity score. In one example, a job industry of Finance and a job industry of Banking can be established to have a similarity score of 0.5. Thus, when determining the industry similarity score of two jobs, one being in the Finance industry, and the second one in the Banking industry, the industry similarity score of those two jobs can be 0.5 according to table 500.

In another example, a job industry of IT and a job industry of Software can be established to have a similarity score of 0.5. In yet another example, a job industry of Internet and a job industry of Software can be established to have a similarity score of 0.5.

In one embodiment, the industry similarity score can be calculated by comparing a first job industry and a second job industry. If the industries match, then the industry similarity can be 1 in a scale from 0 to 1. If the industries do not match, a search can be performed in the similarity table 500 to look for the pair of industries and determine the similarity score. If the industry pair is not in the similarity table 500, then the similarity score is zero.

In another embodiment, the industry similarity score can be calculated by comparing a first job industry and a second job industry. If the industry pair is in the similarity table 500 then the industry similarity score between the first job and the second job is the similarity score corresponding to the industry pair in the similarity table 500.

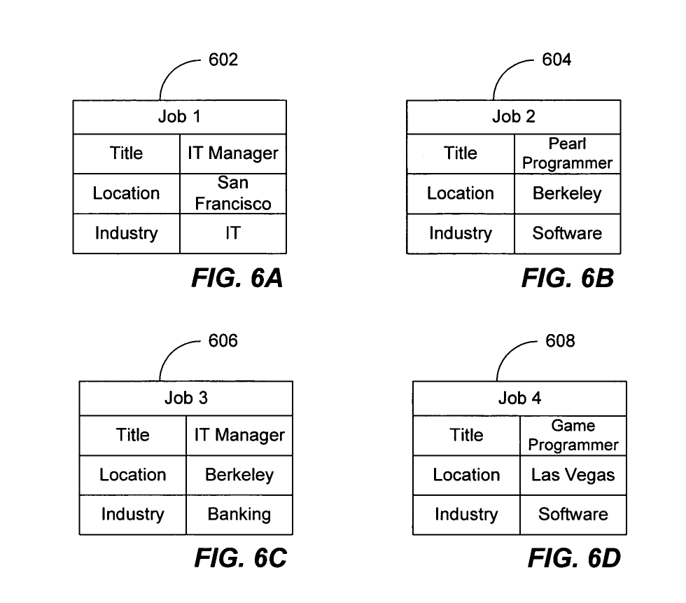

FIGS. 6A-6D illustrate exemplary jobs listed by the job listing provider. Any number of job listings can be provided by a job listing provider. For illustration purpose only, four jobs are depicted in FIGS. 6A-6D: first job 602, second job 604, third job 606, and fourth job 608. The affinity among these jobs can be established based on existing attributes of each of the first job 602, second job 604, third job 606, and fourth job 608. User interaction, such as applying or selecting one or more jobs, is not necessary. In one example, the affinity among the first job 602, second job 604, third job 606, and fourth job 608 can be established based on the similarity of the location. In another example, the affinity among the first job 602, second job 604, third job 606, and fourth job 608 can be established based on the similarity of the job listing title. In yet another example, the affinity among the first job 602, second job 604, third job 606, and fourth job 608 can be established based on the number of users that have applied for each job listing.

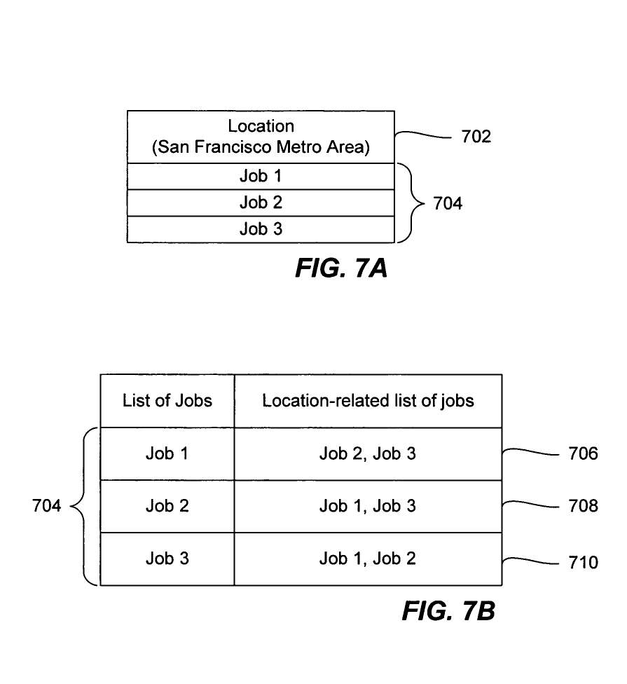

FIG. 7A illustrate an exemplary job list for a predefined job location. The job list 704 corresponds to jobs that are in the jobs database 120 and that have a location attribute in common, namely the San Francisco metropolitan area. Thus, in the exemplary job listings of FIGS. 6A-6D, the first job 602, second job 604, third job 606 have San Francisco or Berkley as the location attribute. Therefore, these three job listings can be included in the job list 704. Any new job that is subsequently added to the jobs database 120, and that has a location attribute value that falls within the geographical location of the San Francisco metropolitan area can be added to the job list 704.

Other location areas can be utilized to build the location job list. Thus, in example, the location job list can correspond to a metropolitan area. In another example, the location job list can correspond to a state. In yet another example, the location job list can correspond to an address.

In addition, thus job lists for any attribute can be created. In one embodiment, a job list of job listings having a common industry can be created. In another embodiment, a job list of job listings having a common title can be created.

FIG. 7B illustrate an exemplary job list for a predefined job location and corresponding affiliated job listings for a predefined job location. In one embodiment, the jobs in the job list 704 can be utilized in order generate an affinity job list for each of the jobs in the job list 704. As such, an affinity job list 706 can be generated, wherein each of the jobs in the affinity job list 706 has an affinity with the first job in the job list 704. In addition, an affinity job list 708 can be generated, wherein each of the jobs in the affinity job list 708 has an affinity with the second job in the job list 704. Further, an affinity job list 710 can be generated, wherein each of the jobs in the affinity job list 710 has an affinity with the third job in the job list 704.

Various algorithms and methodologies can be utilized to generate the affinity job lists 706, 708, and 710. In one example, each job in the job list 704 is affiliated with the rest of the rest of the jobs in the job list 704. The exemplary job list 704 includes Job 1, Job 2, and Job 3.

Thus, in one example, Job 1 of the job list 704 has an affinity job list 706 that includes Job 2 and Job 3. Once a jobseeker applies for Job 1, the user can be recommended to also apply for Job 2 and Job 3. In another example, Job 2 of the job list 704 has an affinity job list 708 that includes Job 1 and Job 3. Once a jobseeker applies for Job 2, the user can be recommended to also apply for Job 1 and Job 3. In yet another example, Job 3 of the job list 704 has an affinity job list 710 that includes Job 1 and Job 2. Once a jobseeker applies for Job 3, the user can be recommended to also apply for Job 1 and Job 2.

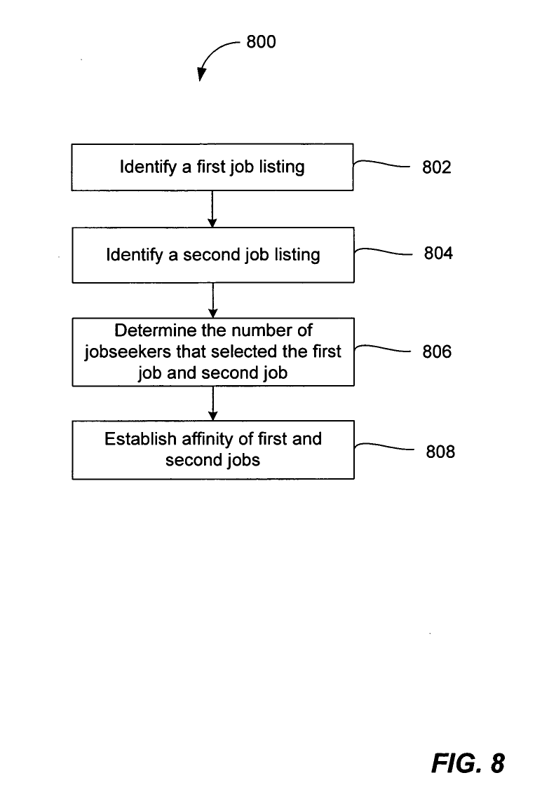

FIG. 8 illustrates a flow diagram for a process of 800 determining job affinity between two job listings. The affinity between two job listings can be determined based on the number of users that have applied to both jobs. In another embodiment, the affinity between two job listings can be determined based on the number of users that have selected both jobs.

At process block 802, a first job listing is identified for comparison. The process 800 continues to process block 804. At process block 804, a second job listing is identified for comparison. The process 800 continues to process block 806.

At process block 806, the number of jobseekers that selected the first job listing and the second job listing is determined. In one embodiment, the word “selected” means that the jobseekers applied for the first job listing and the second job listing. In another embodiment, the word “selected” means that the jobseekers viewed the first job listing and the second job listing. In yet another embodiment, the word “selected” means that the jobseekers rated the first job listing and the second job listing. Thus, a jobseeker is deemed selected based upon a flexible or application-specific variety of user interaction events. The process 800 continues to process block 808.

At process block 808, the affinity between the first job listing and the second job listing is determined. In one example, the affinity between the first job listing and the second job listing is the number of jobseekers that selected both the first job listing and the second job listing. In another example, the affinity between the first job listing and the second job listing is a number proportional to the number of jobseekers that selected both the first job listing and the second job listing.

In one embodiment, the affinity is only established if the number of jobseekers is greater than a predetermined threshold level. For example, a threshold level of 2 can be established, such that affinity between the first job and the second job is established only if at least two jobseekers have selected both the first job and the second job.

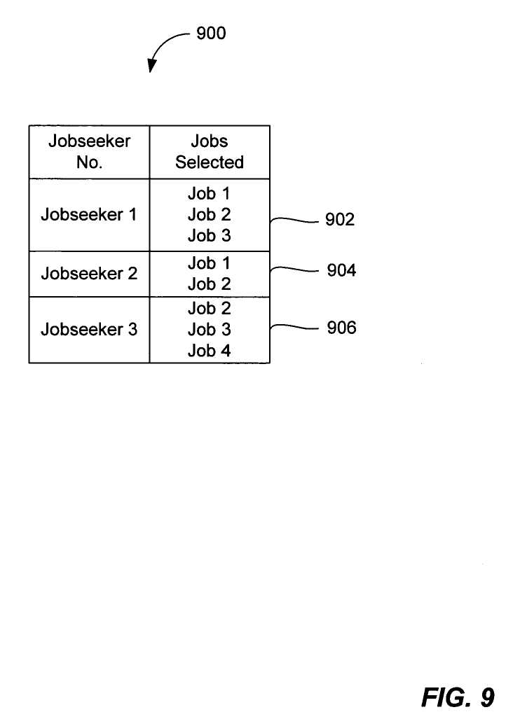

FIG. 9 illustrates an exemplary list of jobs selected by a plurality of jobseekers. According to the example illustrated in FIG. 9, each job seeker has selected one or more of the jobs illustrated in FIGS. 6A-6D. A plurality of jobs 902 comprises the first job 602, the second job 604, and the third job 606. A plurality of jobs 904 comprises the first job 602, and the second job 604. A plurality of jobs 906 comprises the second job 604, the third job 606, and the fourth job 608.

In one example, a first jobseeker applies for a plurality of jobs 902, a second jobseeker applies for a plurality of jobs 904, and a third jobseeker applies for a plurality of jobs 906. In another example, a first jobseeker submits his resume for a plurality of jobs 902, a second jobseeker submits his resume for a plurality of jobs 904, and a third jobseeker submits his resume for a plurality of jobs 906.

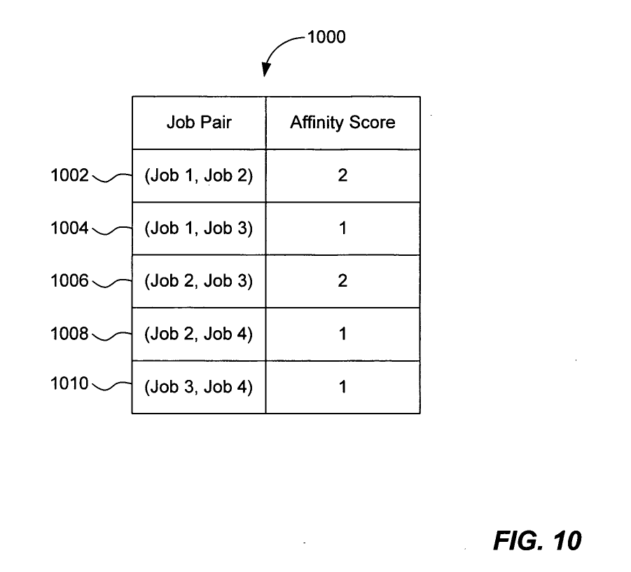

FIG. 10 illustrate exemplary affinity score table 1000 for a plurality of job pair combinations. The affinity score table 1000 includes a list of all job pair combinations of Job 1, Job 2, Job 3, and Job 4. In one example, the jobs listed in the affinity score table 900 are the first job 602, the second job 604, the third job 606 and the fourth job 608.

Moreover, job pair 1002 is the job pair combination (Job 1, Job 2) and it has an affinity score of 2. The affinity score 2 indicates that two jobseekers have applied for both Job 1 and Job 2. Job pair 1004 is the job pair combination (Job 1, Job 3), and it has an affinity score with a value of one. The affinity score 1 indicates that one jobseeker has applied for both Job 1 and Job 3. Job pair 1006 is the job pair combination (Job 2, Job 3), and it has an affinity score with a value of two. The affinity score 2 indicates that two jobseekers have applied for both Job 2 and Job 3. Job pair 1008 is the job pair combination (Job 2, Job 4), and it has an affinity score with a value of one. The affinity score 1 indicates that one jobseeker has applied for both Job 2 and Job 4. Job pair 1010 is the job pair combination (Job 3, Job 4), and it has an affinity score with a value of one. The affinity score 1 indicates that one jobseeker has applied for both Job 3 and Job 4.

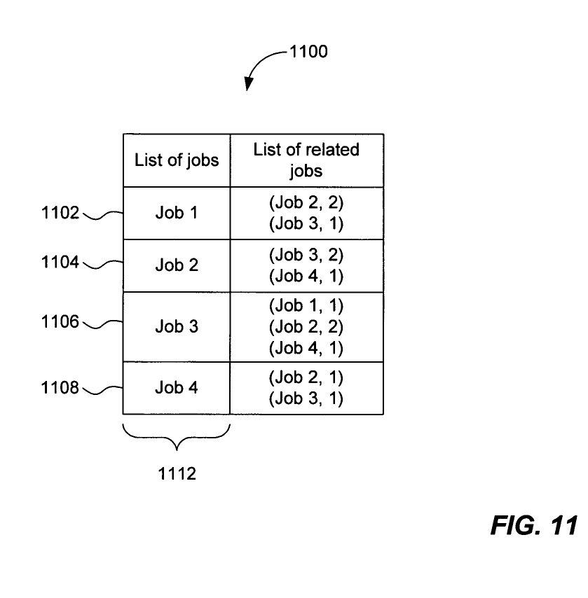

FIG. 11 illustrate an exemplary list of jobs 1112 and corresponding related jobs for each job in the list of jobs 1112. The list of jobs 1112 includes an exemplary list of jobs as illustrated in FIGS. 6A-6D. In another embodiment, other lists of jobs can be utilized. For example, the list of jobs 1112 is a comprehensive list of all of the jobs that are stored in the job database 120.

The list of jobs 1112 can be utilized to quickly recommend jobs to jobseekers who have selected a job in the list of jobs 1112. In one embodiment, a list of corresponding affiliated jobs is provided for each job in the list of jobs 1112. In another embodiment, a list of job-value pairs can be provided. The job value pairs can include a job identifier and an affinity score of the job in the job-value pair. Alternatively, the job value pairs can include a job identifier and the number of users who have selected the job in the job-value pair.

Thus, for example, if the jobseeker selects job 1102, namely Job 1, the user can be recommended Job 2 and Job 3. In addition, if the number of common jobseekers can also be provided. Thus, the jobseeker can be further provided with the information that two other jobseekers who have applied for job 1102, namely Job 1, have also applied for Job 2. Alternatively, the jobseeker can be informed that one other jobseeker who has applied for Job 1 has also applied for Job 3.

In another example, if the jobseeker selects job 1104, namely Job 2, the user can be recommended Job 3 and Job 4. In addition, if the number of common jobseekers can also be provided. Thus, the jobseeker can be further provided with the information that two other jobseekers who have applied for job 1104, namely Job 2, have also applied for Job 3. Alternatively, the jobseeker can be informed that one other jobseeker who has applied for Job 2 has also applied for Job 4.

In yet another example, if the jobseeker selects job 1106, namely Job 3, the user can be recommended Job 1, Job 2 and Job 4. In addition, if the number of common jobseekers can also be provided. Thus, the jobseeker can be further provided with the information that one other jobseeker who has applied for job 1106, namely Job 3, has also applied for Job 1. Moreover, the jobseeker can be informed that two other jobseekers who have applied for Job 3 have also applied for Job 2. Alternatively, the jobseeker can be informed that one other jobseeker who has applied for Job 3 has also applied for Job 4.

In another example, if the jobseeker selects job 1108, namely Job 4, the user can be recommended Job 2 and Job 3. In addition, if the number of common jobseekers can also be provided. Thus, the jobseeker can be further provided with the information that one other jobseeker who has applied for job 1108, namely Job 4, has also applied for Job 2. Alternatively, the jobseeker can be informed that one other jobseeker who has applied for Job 4 has also applied for Job 3.

While the apparatus and method have been described in terms of what are presently considered the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. In addition, attributes utilized in some examples, the number of users or jobseekers, and other particular details are disclosed for discussion and exemplary purposes only. The present disclosure includes any and all embodiments of the following claims.

1. A method of establishing affinity of two job listings, comprising:
identifying a first job listing, the first job listing having a first job listing attribute;
identifying a second job listing, the second job listing having a second job listing attribute;
comparing a first job listing attribute value and a second job listing attribute value to determine if the first job listing attribute and the second job listing attribute are similar according to a predefined set of rules; and
affiliating the first job listing and the second job listing if the first job listing attribute and the second job listing attribute are determined to be similar.

2. The method of claim 1, further comprising recommending the second job listing to a new jobseeker when the new jobseeker selects the first job listing, if the first job listing and the second job listing are affiliated.

3. The method of claim 1, further comprising recommending the first job listing to a new jobseeker when the new jobseeker selects the second job listing, if the first job listing and the second job listing are affiliated.

4. The method of claim 1, further comprising posting the job listings on an Internet website hosted by a computer server, wherein the jobseeker can apply to the first job listing and the second job listing electronically through a computing device that communicates with the computer server through a computer network.

5. The method of claim 1, wherein the set of rules indicate that the first job listing attribute and the second job listing attribute are similar when the first job listing attribute value and the second job listing attribute value are identical.

6. The method of claim 1, wherein the set of rules indicate that the first job listing attribute and the second job listing attribute are similar when the first job listing attribute value and the second job listing attribute value are deemed equivalent based on a heuristic model.

7. The method of claim 1, wherein the set of rules indicate that the first job listing attribute and the second job listing attribute are similar according to a predetermine table of value pairs that are considered to be similar.

8. The method of claim 1, wherein the first job listing attribute is a first location of the first job listing, and the second job listing attribute is a second location of the second job listing.

9. The method of claim 1, wherein the first job listing attribute is a first title of the first job listing, and the second job listing attribute is a second title of the second job listing.

10. The method of claim 1, wherein the first job listing attribute is a first industry of the first job listing, and the second job listing attribute is a second industry of the second job listing.

11. The method of claim 1, wherein the first job listing attribute corresponds to a list of jobseekers that have applied to the first job listing, and the second job listing attribute corresponds to a list of jobseekers that have applied to the second job listing.

12. A system that establishes affinity of job listings, comprising:
a jobs database that includes a first job listing and a second job listing, the first job listing having a first job listing attribute, and the second job listing having a second job listing attribute; and
an affinity module configured to compare a first job listing attribute value and a second job listing attribute value to determine if the first job listing attribute and the second job listing attribute are similar according to a predefined set of rules, wherein the affinity module affiliates the first job listing and the second job listing if the affinity module determines that the first job listing attribute and the second job listing attribute are similar.

13. The system of claim 12, wherein if the first job listing attribute and the second job listing attribute are similar, the second job listing can be recommended to a new jobseeker when the new jobseeker applies for the first job listing.

14. The system of claim 12, wherein if the first job listing attribute and the second job listing attribute are similar, the first job listing can be recommended to a new jobseeker when the new jobseeker applies for the second job listing.

15. The system of claim 12, wherein the job listings are posted on an Internet website hosted by a computer server, wherein the jobseeker can apply to the first job listing and the second job listing electronically through a computing device that communicates with the computer server through a computer network.

16. The system of claim 12, wherein the set of rules indicate that the first job listing attribute and the second job listing attribute are similar when the first job listing attribute value and the second job listing attribute value are identical.

17. The system of claim 12, wherein the set of rules indicate that the first job listing attribute and the second job listing attribute are similar according to a predetermine table of value pairs that are considered to be similar.

18. The system of claim 12, wherein the set of rules indicate that the first job listing attribute and the second job listing attribute are similar when the first job listing attribute value and the second job listing attribute value are equivalent based on a heuristic model.

19. A method of establishing affinity of job listings, comprising:
identifying a first job listing and a second job listing;
determining a number of jobseekers that apply for the first job listing and the second job listing; and
affiliating the first job listing and the second job listing if the number of jobseekers that apply for both the first job listing and the second job listing is higher than a predetermined threshold.

20. The method of claim 19, further comprising recommending the second job listing to a new jobseeker when the new jobseeker applies for the first job listing, if the first job listing and the second job listing are affiliated.

21. The method of claim 19, further comprising recommending the first job listing to a new jobseeker when the new jobseeker applies for the second job listing, if the first job listing and the second job listing are affiliated.

22. The method of claim 19, further comprising:
identifying a third job listing;
determining a second number of jobseekers that apply for the first job listing and the third job listing; and
affiliating the first job listing and the third job listing if the second number of jobseekers that apply for both the first job listing and the third job listing is higher than a second predetermined threshold.

23. The method of claim 22, further comprising recommending the third job listing to a new jobseeker when the new jobseeker applies for the first job listing, if the first job listing and the third job listing are affiliated.

24. The method of claim 23, further comprising posting the job listings on an Internet website hosted by a computer server, wherein the jobseeker can apply to the first job listing and the second job listing electronically through a computing device that communicates with the computer server through a computer network.

25. The method of claim 23, further comprising receiving said predefined threshold level as established by the jobseeker.

26. The method of claim 23, wherein the threshold level is zero.
